(19) United States
(12) Patent Application Publication
(10) Pub. No.: US 2009/0007501 A1
(43) Pub. Date: Jan. 8, 2009

(54) NON-COMBUSTIBLE KITCHEN SYSTEM AND METHOD FOR MAKING SAME

(76) Inventor: David James Belyan, Deland, FL (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/167,582

(22) Filed: Jul. 3, 2008

Related U.S. Application Data
(60) Provisional application No. 60/947,930, filed on Jul. 3, 2007.

(51) Int. Cl. E04C 2/38; F16B 25/10; E04B 1/35

(52) U.S. Cl. 52/127.6; 411/387.1; 52/741.1

(57) ABSTRACT

Disclosed are systems and methods for non-combustible kitchen systems. A rigid frame is coupled to sheet material to form a non-combustible kitchen structure. Various finishing materials such as stone or tile are coupled to the structure. The non-combustible kitchen system exhibits improved resistance to heat and weather damage, such as damage incurred when a user leaves a grill element burning for an extended period of time.

### CROSS-REFERENCE TO RELATED APPLICATIONS

This application claims benefit of and priority to U.S. Provisional Patent Application No. 60/947,930, titled “NON-COMBUSTIBLE OUTDOOR KITCHEN SYSTEM AND METHOD FOR MAKING SAME” filed on Jul. 3, 2007, and which is incorporated herein by reference.

### FIELD OF INVENTION

The present invention relates to kitchen systems. More particularly, the present invention relates to a non-combustible kitchen system and method for making the same.

### BACKGROUND

The popularity and demand for versatile outdoor patios for entertaining and family enjoyment continues to grow rapidly around the country, particularly in warm weather destinations like Arizona, Florida and Texas, among others. For example, households, hotels, and other like facilities are providing elaborate outdoor kitchens, including countertops and bar areas, to enjoy the outdoor environment.

Traditionally, outdoor kitchen areas, such as countertops, have been combustible, prone to deterioration, and/or not as long lasting against weather elements as desired. For example, present outdoor kitchens are typically built out of wood and laminates. These outdoor kitchens are prone to catching fire, e.g., due to a user forgetting to turn off a built in grill or stove. Further, eventually weather elements can cause deterioration such as rotting, and thus the outdoor kitchen materials need to be replaced, often within 5 to 7 years of original construction. Additionally, building codes may become more rigid in the future, requiring outdoor kitchen areas to feature improved fire resistance.

Accordingly, a need exists for improved kitchen structures, including countertops and method of making such kitchens that are non-combustible, longer lasting, and safer for consumers.

### SUMMARY

In accordance with various aspects of the present invention, an improved non-combustible kitchen system and method for making the same are provided. In accordance with an exemplary embodiment, a non-combustible kitchen system comprises a non-combustible, rigid frame, and a non-combustible sheet material coupled to the frame to form an enclosure. Finishing material, such as tile or stone, is coupled to the sheet material and frame.

In accordance with another exemplary embodiment, a method for constructing a non-combustible kitchen apparatus comprises providing a non-combustible, rigid frame, and coupling a non-combustible sheet material to the rigid frame. Finishing material, such as tile or stone, is coupled to the sheet material and frame.

### BRIEF DESCRIPTION OF THE DRAWINGS

With reference to the following description, appended claims, and accompanying drawings:

FIG. 1 illustrates a block diagram of a non-combustible kitchen system in accordance with an exemplary embodiment of the present invention;

FIG. 2 illustrates a frame structure in accordance with an exemplary embodiment of the present invention;

FIG. 3 illustrates exemplary taping or laying out of a kitchen system in accordance with an exemplary embodiment of the present invention;

FIGS. 4 and 5 illustrate coupling frame structure members to each other and/or to the ground or walls in accordance with an exemplary embodiment of the present invention;

FIG. 6 illustrates portions of a frame structure in accordance with an exemplary embodiment of the present invention;

FIGS. 7 and 8 illustrate coupling sheet material to a frame structure in accordance with an exemplary embodiment of the present invention;

FIG. 9 illustrates coupling frame structure members to each other and/or to a wall in accordance with an exemplary embodiment of the present invention;

FIGS. 10 and 11 illustrate installation of a natural stone façade on cement board in accordance with an exemplary embodiment of the present invention;

FIGS. 12 and 13 illustrate coupling sheet material to a frame structure to form a countertop area in accordance with an exemplary embodiment of the present invention; and

FIGS. 14 and 15 illustrate utilizing multiple layers of sheet material in accordance with an exemplary embodiment of the present invention.

### DETAILED DESCRIPTION

The present invention may be described herein in terms of various functional components and various processing steps. It should be appreciated that such functional components may be realized by any number of hardware or structural components configured to perform the specified functions. For example, the present invention may employ various alloys, composites, fasteners, adhesives and the like whose structure and composition may be suitably configured for various intended purposes. In addition, the present invention may be practiced in any structural application where countertops or furniture are desired, and the examples for kitchen structures illustrated herein are merely for exemplary purposes, as the invention can be applied to any structure.

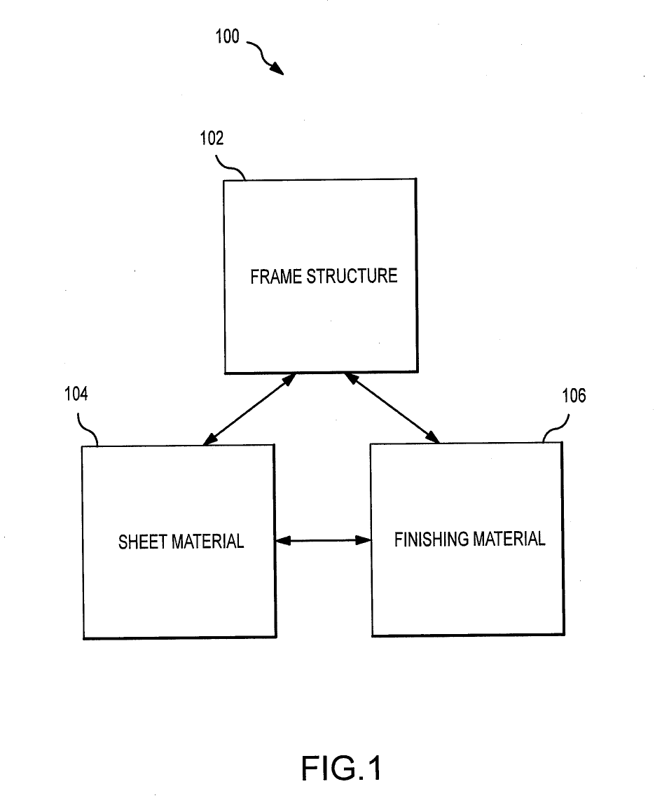

In accordance with various aspects of the present invention, a non-combustible kitchen system and method for making same are provided. With reference to FIG. 1, and in accordance with an exemplary embodiment, a non-combustible kitchen system 100 comprises a frame structure 102 configured with a desired size and shape. Such size and shape can comprise any width, length, and/or depth, as well as any shapes, such as “L”- or “U”-shaped configurations, or any other configurations for kitchen countertops, supports, cabinets, and the like. System 100 further comprises a non-combustible sheet material 104, such as a cement board (e.g., Durock®, Hydropanel, and the like), coupled to frame structure 102. Finishing material 106, such as ceramic tile, may be coupled to frame structure 102 and/or sheet material 104, such as to provide a suitable cooking surface and/or an aesthetically pleasing structure.

For purposes of this disclosure, “non-combustible” means fire-resistant, such as being able to withstand temperatures in excess of six hundred degrees Fahrenheit for a period exceeding one hour without igniting or combusting.

Frame

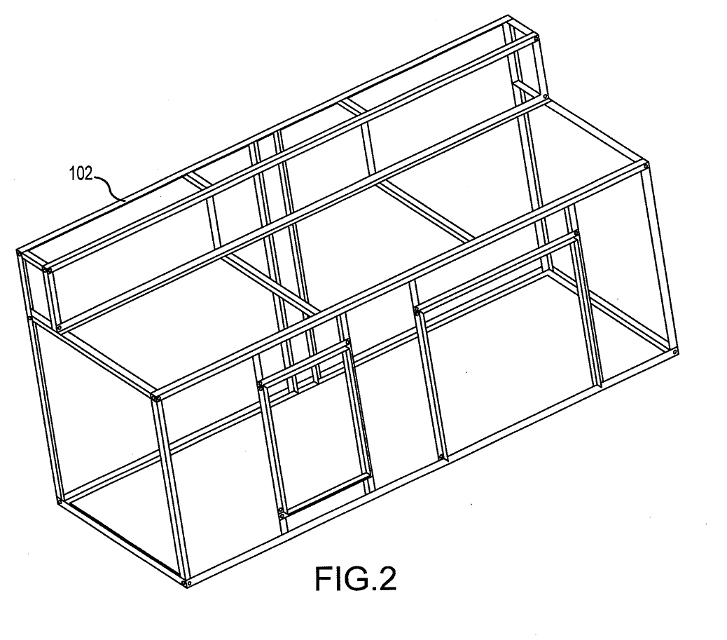

Referring now to FIGS. 1 and 2 and in accordance with an exemplary embodiment, frame structure 102 comprises a rigid non-combustible material, such as metal. Frame structure 102 may comprise aluminum, steel, copper, magnesium, titanium, or other suitable durable metal, and/or various alloys of or variations on the same, such as stainless steel, A36 steel, galvanized steel, duralumin, silumin, 6061 aluminum, and the like, or any combination thereof. Frame structure 102 may also comprise composite material (e.g., carbon fiber and the like), ceramics, and/or similar. Moreover, frame structure 102 may comprise any non-combustible material configured to support kitchen system 100.

Further, frame structure 102 may comprise combinations of materials, such as steel portions, aluminum portions, and the like. Frame structure 102 may also comprise various internal support structures (e.g., braces, crossbars, and similar) to support and strengthen kitchen system 100. Individual components of frame structure 102 may be coupled together, such as via welding, riveting, or use of screws, bolts, and the like. Additionally, frame structure 102 may define the outline of various portions of kitchen system 100, such as side walls, cabinets, shelves, recesses, countertops, and the like.

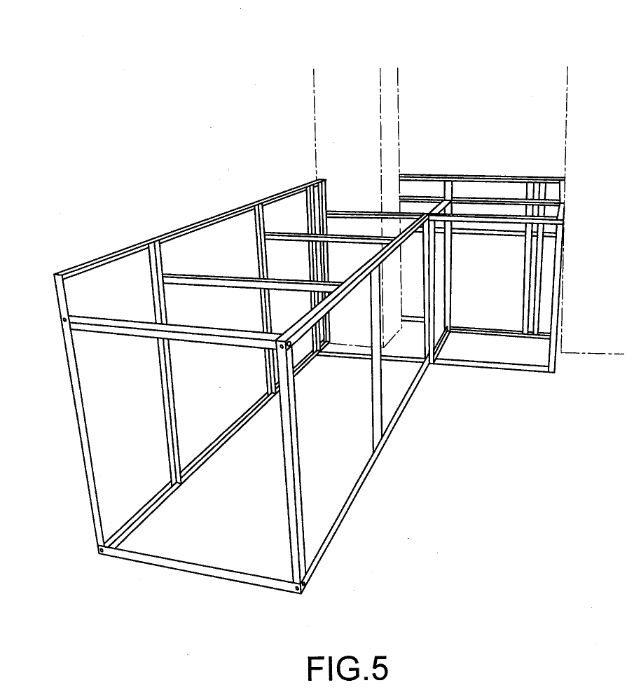

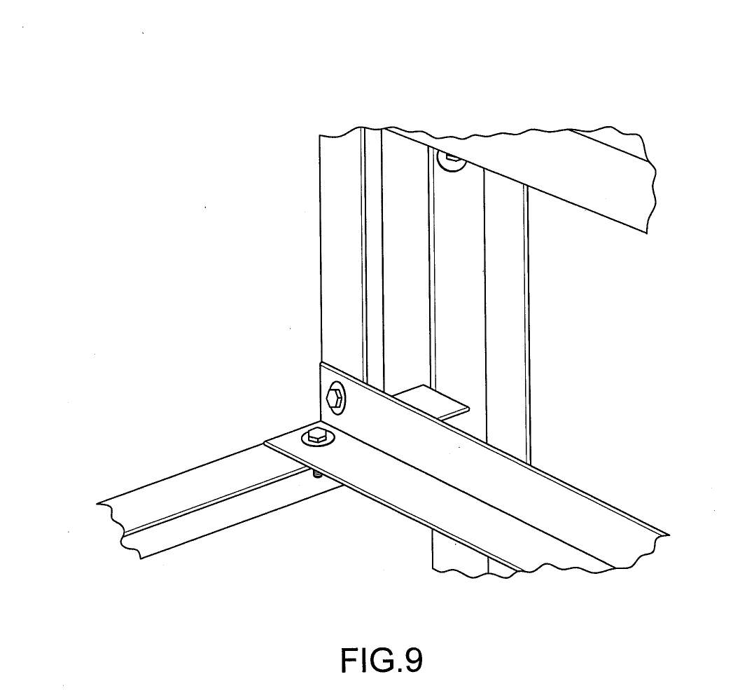

In accordance with an exemplary embodiment and with further reference to FIGS. 5 and 9, frame structure 102 is coupled to the ground in a desired location. Frame structure 102 may also be secured to walls, pillars, fences, and the like. Frame structure 102 is secured in place via fastening hardware (e.g., bolts, concrete screws, rivets, clamps, or similar). Alternatively, frame structure 102 is secured in place via a bonding material, such as a cement or adhesive. Portions of frame structure 102 may be coupled to the ground, and additional portions of frame structure 102 may then be coupled to the secured portions of frame structure 102 to form a desired full frame structure 102. Alternatively, frame structure 102 may be coupled to the ground in a fully assembled form.

In another exemplary embodiment, frame structure 102 rests on the ground but is not coupled to the ground. In this manner, kitchen system 102 may be moved or relocated if desired.

Sheet Material

With reference now to FIG. 1 and in accordance with an exemplary embodiment, non-combustible sheet material 104 is coupled to frame structure 102. In an exemplary embodiment, sheet material 104 comprises Durock® brand cement board. Other types of cement board may also be used, provided such cement board does not contain combustible filler material. Sheet material 104 may also comprise various other non-combustible materials, such as stone, glass, fiberglass, metal, ceramic tile, gypsum board, composite materials, and the like. Moreover, sheet material 104 may comprise any non-combustible material suitable for coupling to frame structure 102.

Sheet material 104 may comprise various thicknesses, such as between about three-eighths and one inch thick. However, thinner and/or thicker material may be used as appropriate. Moreover, portions of sheet material 104 coupled to frame structure 102 may be a particular thickness in a certain location, and a different thickness in another location. For example, portions of sheet material 104 which comprise side walls of kitchen system 100 may be thinner than portions of sheet material 104 which comprise countertop surfaces of kitchen system 100. Additionally, sheet material 104 may comprise a single layer material, multiple layers of the same material, multiple layers of different materials, or any combination of the same.

Additionally, sheet material 104 may comprise a particular material in a certain location, and a different material in another location. For example, side wall portions of sheet material 104 may comprise cement board, while countertop portions of sheet material 104 may comprise finished stone such as granite or marble.

Sheet material 104 is coupled to frame structure 102. In an exemplary embodiment, sheet material 104 may be coupled to frame structure 102 via fasteners comprising 1″ #8×32 self-tapping screws. Sheet material 104 may also be coupled to frame structure 102 via other mechanical fasteners such as screws, bolts, clamps, rivets, and the like. Further, such fasteners may be ground, filed, sanded, or otherwise modified after installation in order to achieve a smoother surface on sheet material 104. To facilitate coupling to frame structure 102, portions of sheet material 104 may be removed, such as by drilling, cutting, or sawing. Adhesives, welding, and other known coupling methods may also be used to secure sheet material 104 to frame structure 102.

When coupled to frame structure 102, sheet material 104 provides increased rigidity and/or structural support to kitchen system 100. Sheet material 104 may also define functional portions of kitchen system 100, such as countertop surfaces, shelves, cabinets, recesses, and the like.

Sheet material 104 may also thermally isolate certain portions of kitchen system 100. For example, sheet material 104 may limit heat transfer between cooking areas of kitchen system 100 and other areas of kitchen system 100. Additionally, sheet material 104 may be located in such a manner as to insulate and/or protect materials located inside kitchen system 100, such as coated electrical wires, PVC pipes, rubber grommets, rubber hoses, electric motors, solenoids, valves, switches, and similar. In this manner, materials located inside of and/or adjacent to kitchen system 100 are protected from excessive heat exposure even if an installed cooking appliance is inadvertently left on for an extended period of time.

Finishing Material

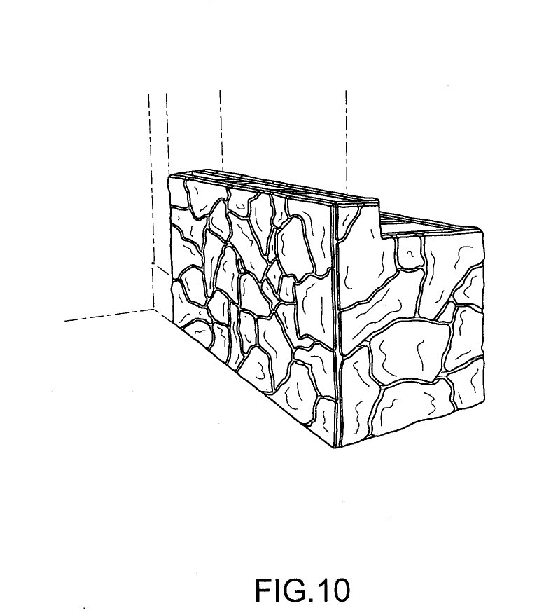

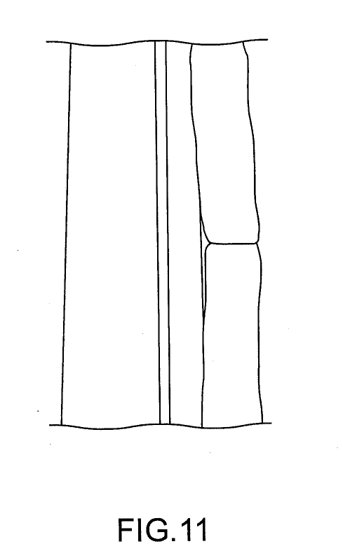

With reference to FIGS. 1, 10, and 11 and in accordance with an exemplary embodiment, finishing material 106 may be coupled to portions of kitchen system 100. Finishing material 106 may be coupled to frame structure 102 and/or sheet material 104.

In accordance with an exemplary embodiment, finishing material 106 comprises stucco. In another exemplary embodiment, finishing material 106 comprises stone. Moreover, finishing material 106 may comprise any desired material configured to achieve a desired appearance of kitchen system 100, such as tile, metal, wood, plastic, composite material, and/or combinations of the same.

Finishing material 106 may be applied using various techniques for applying such finishing materials. Further, finishing material 106 may be utilized to construct and/or embellish various inserts and/or facades, e.g., grills, doors, cabinets, handles, recesses, countertops, and similar.

Method of Construction

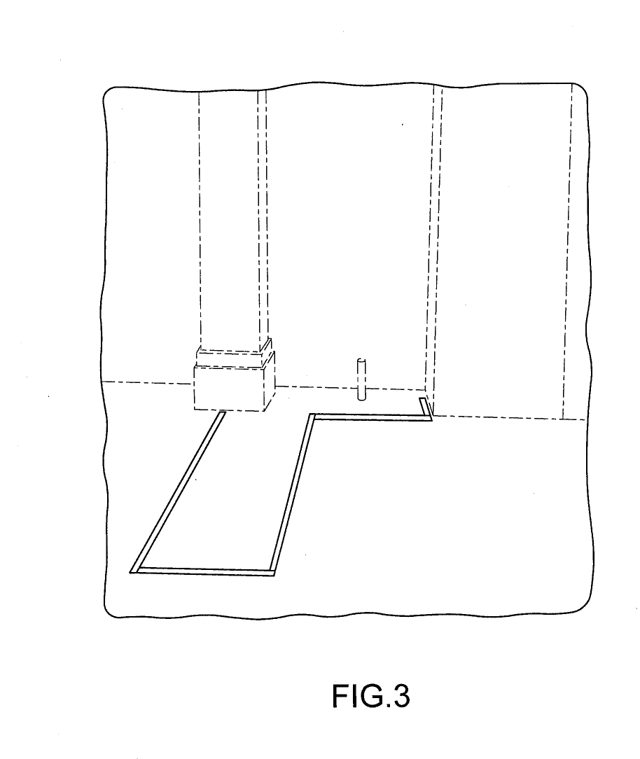

In accordance with an exemplary embodiment, and with reference to FIG. 3, a system builder may lay out selected or desired dimensions of kitchen system 100 in an outline, such as a tape outline on a floor to show a customer the size and shape of kitchen system 100. Such size and shape can be in various configurations, depths, widths, and lengths as desired.

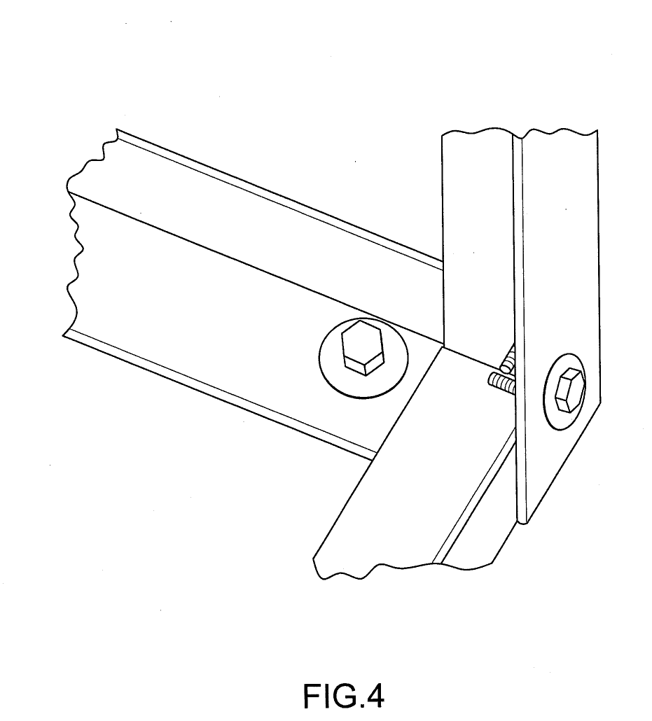

Next, with reference to FIGS. 4, 5, and 9, the builder can suitably secure portions of frame structure 102 to the floor and/or walls to reduce movement of kitchen system 100.

Next, with reference to FIG. 5, the builder can cut to height portions of frame structure 102 to provide a level countertop area on kitchen system 100. Portions of frame structure 102 can be secured together, such as by screwing together with #8×18× 9/16″ self tapping screws, or any other coupling or securing mechanism.

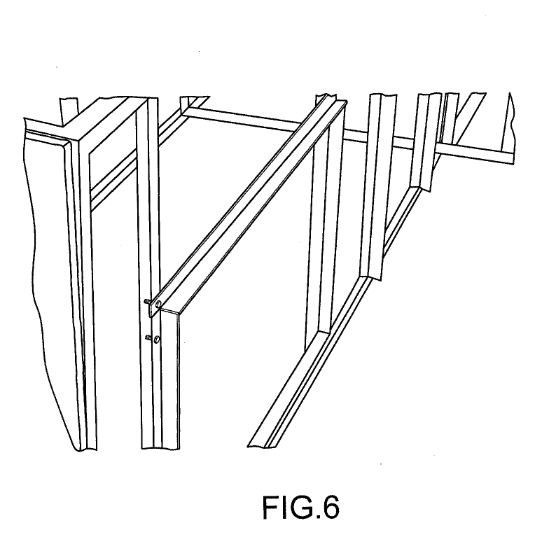

Next, with reference to FIG. 6, portions of frame structure 102 can be installed to expand frame structure 102, such as portions which form the outer frame, grill heads, doors, drawers, side burner, and the like. It should be appreciated that such grill head, doors, drawers, additional burners, and the like can comprise various sizes and configurations, and be located in various positions within kitchen system 100. Additional portions of frame structure 102, such as vertical, horizontal and/or diagonal portions, may also be installed to provide additional bracing, support, framing, and the like.

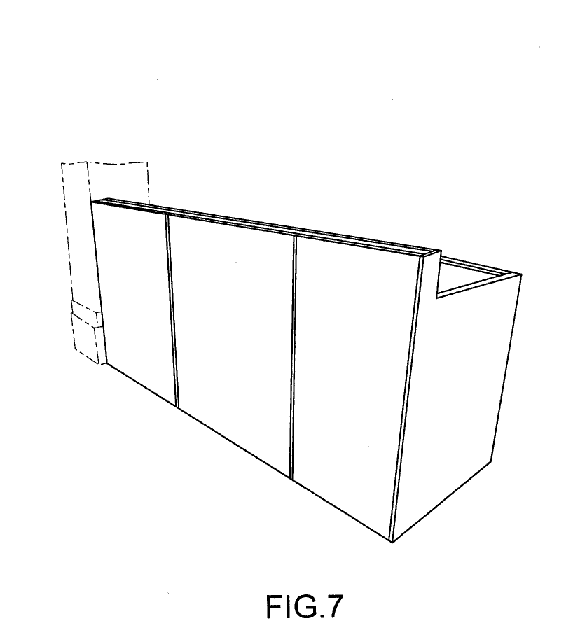

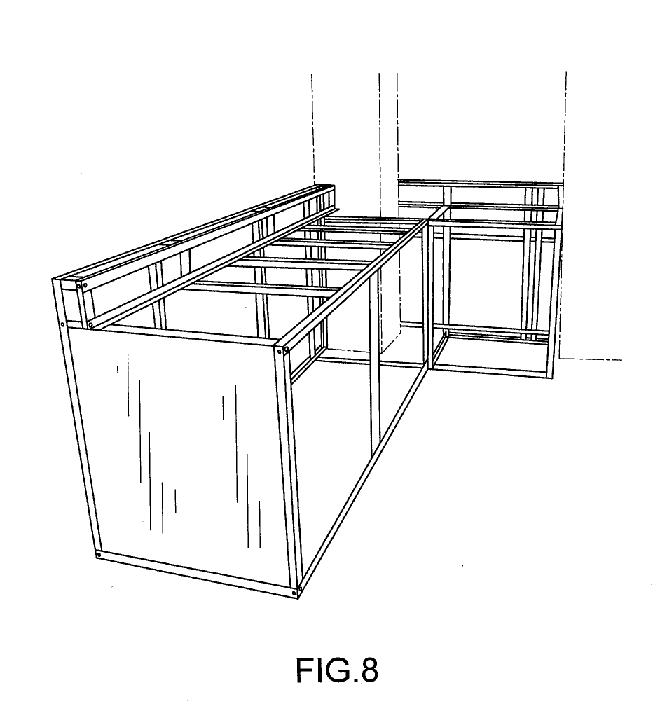

Next, with reference to FIGS. 7 and 8, the builder can install sheet material 104, such as ½″ Durock® brand cement board, to use as a skin for kitchen system 100. The cement board may be secured to the frame structure in various manners, e.g., with 1″ #8×32 self tapping screws.

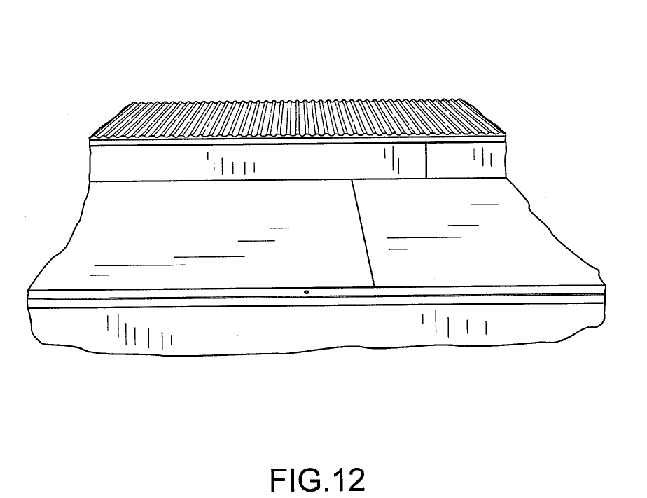

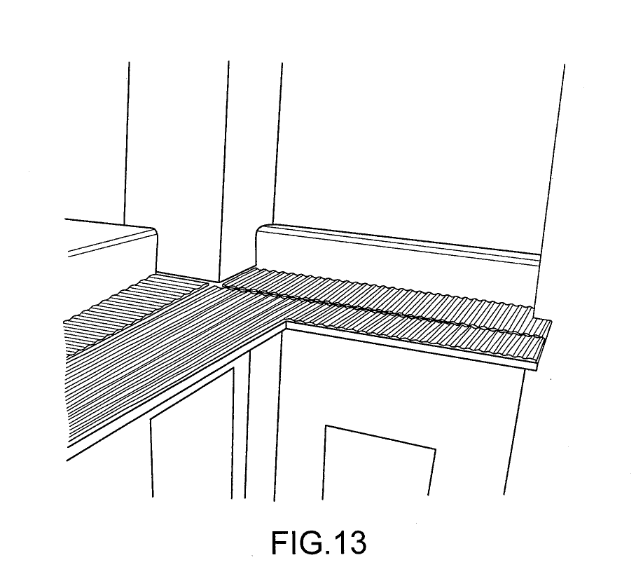

Next, with reference to FIGS. 12 and 13, top portions of sheet material 104, such as Durock® brand cement board, are installed. Two overlapping layers of cement board may be installed for additional strength. The first layer of cement board may be coupled to frame structure 102, e.g., with 1″ self tapping screws.

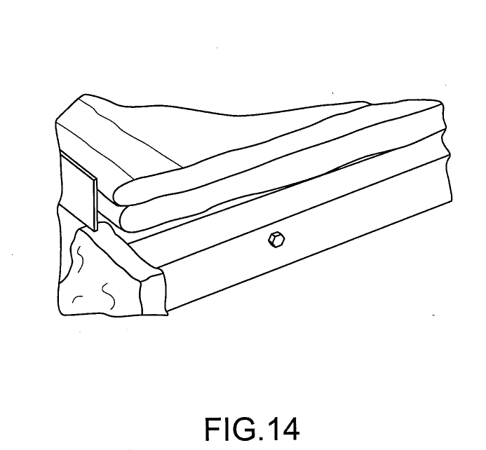

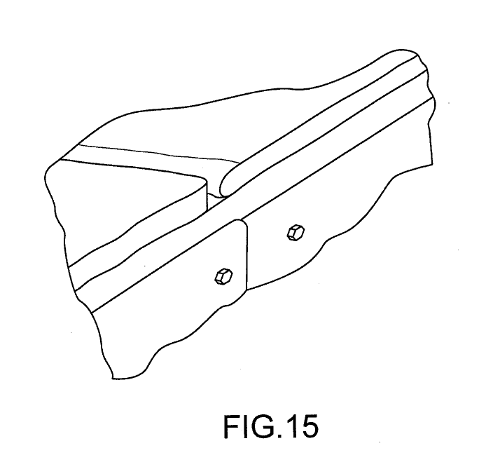

Next, with reference to FIGS. 14 and 15, a second layer of sheet material 104 can be mudded together on top of the first layer of sheet material 104, such as by using a thin-set mortar or other appropriate adhesive, and then pressing the two layers of cement board together. A level may be used to ensure the top portion of kitchen system 100 is level. At this point, seams in kitchen system 100 may be mudded. Further, screening material, such as 6″ wide aluminum screening, duct tape, fiberglass tape, or other suitable durable screening material, may then be applied to prevent cracking.

Countertop material, such as ceramic tile, glass tile, finished stone, and the like, and any combination thereof, may be installed on one or more top portions of kitchen system 100.

Additionally, finishing materials 106, such as stone, may be applied to portions of kitchen system 100, such as side walls. Finishing materials 106 may be coupled to kitchen system 100 via adhesives, mortars, cement, and the like, or any combination thereof.

Once kitchen system 100 is formed, various appliances and accessories may be installed, such as gas grills, charcoal grills, electric griddles, refrigerators, fans, electrical outlets, sinks, plumbing, and the like, or any combination thereof.

The present disclosure sets forth non-combustible kitchen systems and methods that are applicable to various countertop or furniture applications. It will be understood that the foregoing description is of exemplary embodiments of the invention, and that the invention is not limited to the specific forms shown. Various modifications may be made in the design and arrangement of the elements set forth herein without departing from the scope of the invention. For example, the various components and devices can be connected together in various manners in addition to those illustrated in the exemplary embodiments, and the various steps can be conducted in different orders. These and other changes or modifications are intended to be included within the scope of the present invention.

In the foregoing specification, the invention has been described with reference to various embodiments. However, one of ordinary skill in the art appreciates that various modifications and changes can be made without departing from the scope of the present invention as set forth in the claims below. Accordingly, the specification is to be regarded in an illustrative rather than a restrictive sense, and all such modifications are intended to be included within the scope of the present invention. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A non-combustible kitchen apparatus, comprising:
a non-combustible, rigid frame comprising a plurality of rigid, non-combustible members coupled together and configured in a selected size and shape; and
a non-combustible sheet material coupled to said frame to form an enclosure around said frame.

2. The apparatus of claim 1, wherein the frame is metal.

3. The apparatus of claim 1, wherein at least two of the plurality of rigid, non-combustible members are coupled together using self-tapping screws.

4. The apparatus of claim 1, wherein the frame and sheet material are configured to withstand temperatures in excess of 600 degrees Fahrenheit without combusting.

5. The apparatus of claim 1, wherein at least one member of the frame is coupled to the ground.

6. The apparatus of claim 1, wherein the sheet material is configured to provide thermal insulation to a space inside the kitchen apparatus.

7. The apparatus of claim 1, further comprising a finishing material coupled to the frame and the sheet material.

8. The apparatus of claim 2, wherein the sheet material is cement board.

9. The apparatus of claim 2, wherein the frame comprises at least one member comprising a first metal and at least one member comprising a second metal.

10. The apparatus of claim 7, further comprising tile coupled to the frame and the sheet material.

11. The apparatus of claim 7, further comprising stone coupled to the frame and the sheet material.

12. The apparatus of claim 8, wherein the cement board is between about three-eighths and five-eighths of an inch thick.

13. A method for constructing a non-combustible kitchen apparatus, the method comprising:
determining a selected size and shape by outlining a selected area;
providing a non-combustible, rigid frame comprising a plurality of rigid, non-combustible members coupled together and configured in said selected size and shape and provided on said selected area;
coupling a non-combustible sheet material to the rigid frame to form a non-combustible enclosure; and
coupling a finishing material to at least one of the rigid frame and the sheet material.

14. The method of claim 13, wherein the frame forms the outline of at least one of a countertop, a shelf, a cupboard, a door, and a drawer.

15. The method of claim 13, wherein at least two of the plurality of rigid, non-combustible members are coupled together with self-tapping screws.

16. The method of claim 13, wherein the finishing material is at least one of tile, stone, metal, wood, plastic, and composite material.

17. The method of claim 13, further comprising coupling said non-combustible, rigid frame to the ground.
